(19) United States
(12) Patent Application Publication
(10) Pub. No.: US 2026/0071854 A1
(43) Pub. Date: Mar. 12, 2026

(54) CAMERA DETECTION OF POINT OF IMPACT OF A PROJECTILE WITH A PHYSICAL TARGET

(71) Applicant: SensorMetrix, San Diego, CA (US)

(72) Inventor: Anthony F. Starr, San Diego, CA (US)

(21) Appl. No.: 19/106,611

(22) PCT Filed: Aug. 30, 2023
(86) PCT No.: PCT/US2023/031527

§ 371 Date: Feb. 25, 2025

Related U.S. Application Data
(60) Provisional application No. 63/402,460, filed on Aug. 30, 2022.
(60) Provisional application No. 63/402,451, filed on Aug. 30, 2022.

(51) Int. Cl. F41J 5/10; A63B 71/06; G06T 7/70

(52) U.S. Cl. CPC F41J 5/10; A63B 71/0669; G06T 7/70; G06T 2207/30204; G06T 2207/30221

(57) ABSTRACT

Methods, systems, and apparatus, including medium-encoded computer program products, for camera detection of projectile point of impact include: processing at least one of multiple images of a physical target in a field of view of a camera to determine an orientation of the physical target, correct spatial perspective distortion for the physical target, establish a metric for the physical target that relates a pixel-to-pixel distance with a real-world distance, or a combination thereof; comparing respective images in a sequence of images from the multiple images to identify image data representing a projectile having hit the physical target; determining a point of impact of the projectile on the physical target based on the image data representing the projectile having hit the physical target; and providing the determined point of impact for scoring and presentation on a display device.

### CROSS-REFERENCE TO RELATED APPLICATIONS

This application claims the benefit of priority of U.S. Patent Application No. 63/402,460, entitled “REAL-TIME CAMERA DETECTION OF POINT OF IMPACT OF A PROJECTILE WITH A PHYSICAL TARGET”, filed 30 Aug. 2022, and claims the benefit of priority of U.S. Patent Application No. 63/402,451, entitled “CAMERA BASED LOCATING OF A PHYSICAL TARGET IN THREE-DIMENSIONAL SPACE FOR SCORING OF SHOTS USING TRAJECTORY LOCATING SYSTEM”, filed 30 Aug. 2022, both which are incorporated herein by reference.

### BACKGROUND

This specification relates to locating physical targets used in shooting sports competitions and determining the point of impact of bullets, e.g., for scoring during a competition at a shooting range.

Shooters desire to know with precision how the point of impact (POI) at their target compares to their point of aim (POA). This information is useful to enable setting of gun ‘Zero’, the accuracy of rifle, shooter, and/or ammunition, and to score targets for training or in the case of shooting sports competitions. Even for casual or recreational shooting, knowing the POI is desired and yet difficult due to the distance between the shooter and target, the small impact indication (e.g., the hole) caused by the bullet, and the delay between taking the shots and retrieving and manually measuring the shot locations. U.S. Pat. No. 9,360,283 describes a shooting range target system that includes target modules, which each use a camera and a processor to automatically detect shot locations and communicate them to a server, where the accuracy of determining the hit location is improved by highlighting the hole left by the bullet using a target made of a first layer of a first color and a second layer of a second, different color.

### SUMMARY

The present disclosure relates to locating physical targets used in shooting sports competitions and determining the point of impact of bullets, e.g., for scoring during a competition at a shooting range.

Various embodiments of the subject matter described in this specification can be implemented to realize one or more of the following advantages. Highly accurate scoring (e.g., locating the POI with respect to the POA with a positional precision that is about 2%, 1.5%, or 1% of the projectile diameter/caliber and/or with a precision at a level of about 4×10⁻⁵ of the target dimension) can be achieved (e.g., across the entirety of a target) in real time, and without the use of a scoring gauge (which has precision machined cylindrical surfaces that can be inserted into a target hole to assist in manual scoring) or removal of the target for scoring on a scanner. This accuracy can be achieved for a wide range of firearms and different ammunition calibers, since the system is not dependent on the use of a specific firearm, ammunition, or location (e.g., indoors or with a particular acoustic environment surrounding the target area). Further, this accuracy can be achieved without requiring that the target be registered (accurately positioned or precisely known) with respect to a projectile trajectory detection system in advance in order to obtain POI relative to the target, even when the target moves in unpredictable ways as a result of the projectile's impact or other forces (e.g., wind).

No pre-event special target handling/assignments need be required, as the scoring can be specific to the target stand. Using circular symmetry detection methods can further improve accuracy, allowing cold range requirements for scoring to be eliminated while maintaining highly precise POI determination, including detecting target hole positions within 0.1 mm on an 11″×17″ target sheet using a camera resolution of 16.8 Megapixels or less. This is achievable in real time on a “hot” range even with the targets being simply paper targets placed on stands without careful control of their location in 3D space (e.g., the paper target can be attached to a backer or holder without requiring precision placement, or the target and/or target stand can move in the wind). Thus, image analysis techniques can be used to locate specific parts of received images that represent fiducial or reference marks, target aimpoints, and shot impacts, and these image analysis techniques can be used on a series of images of a target to (in real time) detect when a shot occurs, locate target fiducials relative to the camera field of view, locate the POI relative to the camera field of view, locate the POA relative to camera field of view, and perform scoring using prescribed spatial target information (e.g., known scoring radii). Moreover, occurrences of cross-fire (where a shooter fires onto a target that is not assigned to him) can be readily detected in real time and also corrected, which is valuable at a shooting range, especially in competitions or during scored training exercises. Real-time shot detection can be particularly useful in situations where the time of the shot is important, such as in timed competitions.

The details of one or more implementations of the technologies described herein are set forth in the accompanying drawings and the description below. Other features, aspects, and advantages of the disclosed technologies will become apparent from the description, the drawings, and the claims.

### BRIEF DESCRIPTION OF DRAWINGS

FIGS. 1A-1C show examples of shooting range systems used to determine point of impact (POI) and point of aim (POA).

FIG. 2A shows an example of a process performed by one or more computers to determine POI and POA, and perform shot scoring.

FIG. 2B shows an example of a process of comparing images to determine a hit point on a physical target for a projectile.

FIGS. 2C-2F show examples of images of holes formed when projectiles hit paper.

FIG. 3A shows an example of a process performed by one or more computers to determine POI with respect to a scoring region or POA, and perform shot scoring.

FIG. 3B shows an example of a benchrest target.

FIG. 3C shows an example of global and local perspective distortion correction for the benchrest target of FIG. 3B.

FIG. 3D shows an example of detecting an overlapping shot for the benchrest target of FIG. 3B.

FIG. 3E shows an example of a process to provide localized active spatial distortion correction.

FIG. 3F shows an example of a process to provide in-the-field calibration of a target locating system with a trajectory locating system.

Reference numbers and designations in the various drawings indicate exemplary aspects, and/or implementations of particular features of the present disclosure.

### DETAILED DESCRIPTION

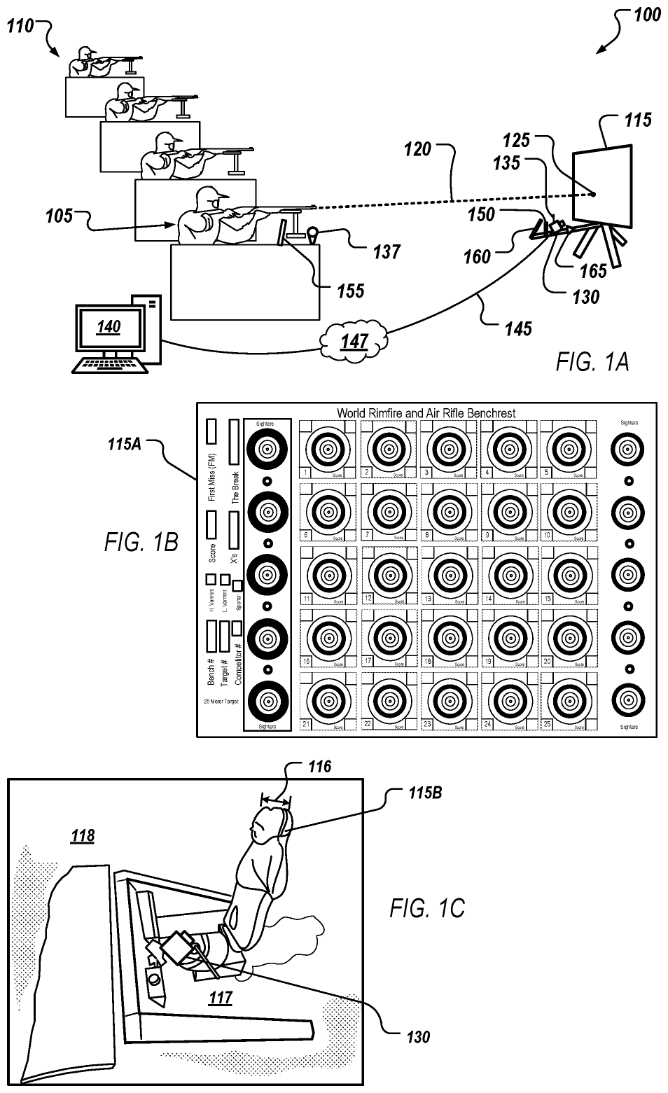

FIG. 1A shows an example of an implementation of a shooting range system 100 used to determine point of impact (POI) and, optionally, point of aim (POA) for projectiles, e.g., bullets. A shooter 105 at a location 110 has an associated physical target 115 at which the shooter 105 aims and fires. In the example shown, the location 110 is a benchrest competition, where each of multiple shooters has their own bench on which to place their firearm, which is used in the competition. Each shooter can have a dedicated target 115 for their shots, or two or more (or all) of the shooters can share a target 115.

FIG. 1B shows an example of a target 115A, as can be used in the shooting range system 100 of FIG. 1A. The target 115A is an example of a target used in 25 m benchrest competitions. The target 115A sheet size is A3 (297×420 mm). The numbered bulls (1-25) are for “record” and officially count in the competition. Note that a “bull” or “bullseye” is the center of a target aiming point, and a target can contain multiple bulls. In the target 115A, the five bulls on either side of the numbered bulls are “sighters” (used by a competitor at will) and do not count in scoring. Typically, these extra bulls are used by the shooter in one or more sighter shots to evaluate his sight adjustment and/or “hold-off”, which is the displacement between the POA and the location where the shooter places the aiming device, e.g., scope reticle; a shooter will normally use ‘hold-off’ to account for the movement of a shot trajectory due to wind (windage holdoff) or for target distance that is different from the “Zero” range (ballistic drop compensation).

The term “zero” refers to adjustment of aiming sights such that the POI occurs at the POA on a target at a specific range. Sights on the gun normally are adjustable in elevation (vertical direction) and windage (horizontal direction). The shooter will normally set these adjustments such that the bullet strikes the POA at a given range. Note that the bullet trajectory is curved due to gravity accelerating the bullet downward once it leaves the gun's muzzle. Further, cross-wind can cause the bullet to drift horizontally along the direction of the cross-wind; therefore the shooter will usually want to make horizontal adjustments to zero wind conditions. Other ballistic factors, such as spin drift or the Coriolis effect, can affect the POI.

Also note that other two dimensional targets, containing one or more aiming points for shooting, can be used. Such targets are often just a sheet of paper, but other physical mediums can also be used for the target, such as metallic or plastic materials. In some implementations, the targets are made of a material that is easily perforated by the projectile, e.g., bullet. In some cases, a paper target may be attached to a second, usually stiffer material known as a backer, that restrains the paper so that a clean bullet hole results, or is “printed” on the target paper.

Moreover, various different types of targets can be used in various implementations of the systems and techniques described in this application. For instance, FIG. 1C shows an example of a three-dimensional physical target 115B, which has a depth dimension 116 larger than a sheet of paper. In this example, the target 115B is a pop-up target located in a ground trench 117 placed in the ground 118. Other configurations and arrangements of the system 100 are also possible, such as described in this specification, including moving targets.

Returning to FIG. 1A, a projectile is shot by the shooter 105 from the location 110 along a path 120 toward the target 115. The POA is the location where the shooter 105 desires to impact the projectile on the target 115, and the POI 125 is the location of a projectile strike on the target 115, which is defined as the position on the target 115 where the cross-sectional center of the projectile strikes the target. While various sensor systems can be used in different implementations, the system 100 includes at least one camera 130, which is positioned to view at least a portion of the physical target 115, 115A, 115B (e.g., the camera 130 is adjacent to the target 115, and the camera can be affixed to or integrated with the target 115). The camera(s) 130 are located outside the line of fire (e.g., below the target 115 as shown) and can be protected by an impact resistant plate or other shielding such as bullet proof transparent material 160 (e.g., bullet proof glass). Thus, each camera 130 will view the target 115 at an angle, and so the resulting spatial perspective distortion is corrected for images generated by the camera 130, as described in further detail below. Spatial perspective distortion is caused by an object plane of the physical medium of the target 115, 115A, 115B being non-parallel with an image plane of the camera 130.

The various sensor systems that can be used include two or more cameras, e.g., a stereo camera 130, one or more antennas 135 of a radar system, an optical beam disruption system (not shown), one or more microphones 137, or other sensor devices suitable for use in determining the POI, the POA, and/or the projectile's path in three dimensional space before reaching the target, e.g., sensor devices used in a trajectory path locating system, which can define the trajectory 120 as a velocity composed of a single direction and a single speed. The system 100 includes one or more computers 140 that are communicatively coupled with the various components of the system (e.g., the camera plus radar system) through a communication link 145. The communication link 145 can be a direct, wire link, a wireless link, and/or be implemented through a network 147. The system 100 can be configured to be compatible with various communication networks, including wireless, cabled, or fiber optic networks 147, and including networks specifically used at shooting ranges, such as the U.S. Army's Future Army System of Integrated Targets (FASIT) network.

The one or more computers 140 are configured (e.g., programmed) to perform operations described in this specification. Thus, the one or more computers 140 can be configured to detect the POI, compare the POI with the POA and/or one or more scoring regions, and do scoring of shots (based on a hit or miss determination or based on shot error, which is the displacement between POA and POI) in real time. In some implementations, the system 100 can work with generic targets placed on target stands.

The system 100 can provide information (e.g., real time scoring information) to one or more display devices, providing shooters, spectators, and event staff with live real-time scoring results. The display devices can include a display device 150 co-located with the target 115 (in front of, and below, the target as shown, or on either side or above the target) and/or a smartphone or tablet computer 155 co-located with the shooter 105. During a competition, the competitor name and/or identifier can be presented on a target stand electronic display device 150, which facilitates shooting bench/point assignments. Further, such display devices 150, 155 can include processing circuitry that is a portion of the one or more computers 140 that perform the processing operations described in this specification. Other locations for one or more of the computer(s) 140 of the system 100 are also possible, such as within the trench 117 (shown in FIG. 1C) for a trench target.

In any case, the display device(s) and computer(s) should be placed out of the line of fire or otherwise protected from damage, at least when the range is hot, e.g., while active shooting taking place. Thus, in some implementations, the display device 150 (which can be positioned in front of, or adjacent to, the physical target 115) has bullet proof transparent material 160 (e.g., bullet proof glass) positioned in front of the display device 150, where the bullet proof transparent material 160 is angled to deflect bullets in a direction that is away from both the physical target 115 and the shooter 105. Note that each shooter can have a dedicated display device 150, 155 and/or two or more (or all) of the shooters can share a display device 150, which need not be placed directly in front of the target 115. In addition to presenting text and/or images representing scoring information, the display device 150, 155 can be used to indicate bench number, competitor name, event, time, time remaining, range or competition status (e.g., an indicator of target or range conditions, such as the range being “hot” or “cold”, meant to be seen by a shooter in the shooting area), or other information. Thus, a display device 150 that is adjacent to the target 115 (e.g., affixed to or integrated with the target) that the shooter is focused on provides ease of use and corresponding safety benefits on a range. In addition, in some implementations, the system is configured to connect with remote network(s), server(s) and computer(s) (e.g., system 100 provides remote access through the network 147) and allows provision of the acquired images and/or scoring or other information from the target location to remote users (e.g., range safety officers that may not be on-site) and can enable those remote users to control the display, lights and indicators that provide information on the conditions of the range, competition status, or other shooting related information.

The system 100 can also include additional components, such as a light source 165, which can be protected by bullet proof transparent material 160 or otherwise protected, e.g., by being placed in the trench 117 or having non-transparent shielding in front of it (e.g., protected by a hardened faceplate, such as AR500). The light source 165 provides illumination of the target for night/dark shooting, and can also be used to augment natural, ambient lighting, to provide more even illumination (e.g., shadow fill), to improve target visibility for the shooter, and/or to adjust the color scheme (e.g., illuminate the target for a particular shooter with a particular color). In some implementations, the shooter can also adjust the lighting to his or her liking.

Moreover, the one or more computers 140 can include a ballistics analysis computer 140 programmed to define the trajectory 120 of the projectile within a target volume, e.g., in front of the target 115, using images from one or more cameras 130. Note that the projectile can be presumed to have a constant speed along a linear path in three-dimensional space within the target volume of detection. While the presumption of a linear path is not fully accurate, it is essentially accurate given the transit time of the projectile in relation to the gravitational acceleration of the Earth. The assumption of constant speed is essentially accurate for munitions with high ballistic coefficients or low aerodynamic drag when forward (or backward) projecting the trajectory to intersect any arbitrary target surface. If further precision is needed, the defined linear trajectory can be converted into a curved, velocity varying trajectory using physics-based ballistic simulation (e.g., using the known gravitational pull of the Earth, a known or determined mass of the projectile, a measured wind speed and direction, and a known or determined size and shape of the projectile). Moreover, an approximate ballistic trajectory calculation can be made to provide an approximate forward or reverse trajectory estimation. For additional details regarding examples of systems and techniques that can be used in combination with the subject matter of the present application, see International Application No. PCT/US2019/045371 (published as WO 2020/068277 on Apr. 2, 2020), U.S. application Ser. No. 17/714,084 (filed on Apr. 5, 2022, and published on Dec. 29, 2022 as U.S. Publication No. 2022-0413118-A1), and U.S. application Ser. No. 17/714,088 (filed on Apr. 5, 2022, and published on Dec. 29, 2022 as U.S. Publication No. US-2022-0413119-A1), each of which are hereby incorporated by reference.

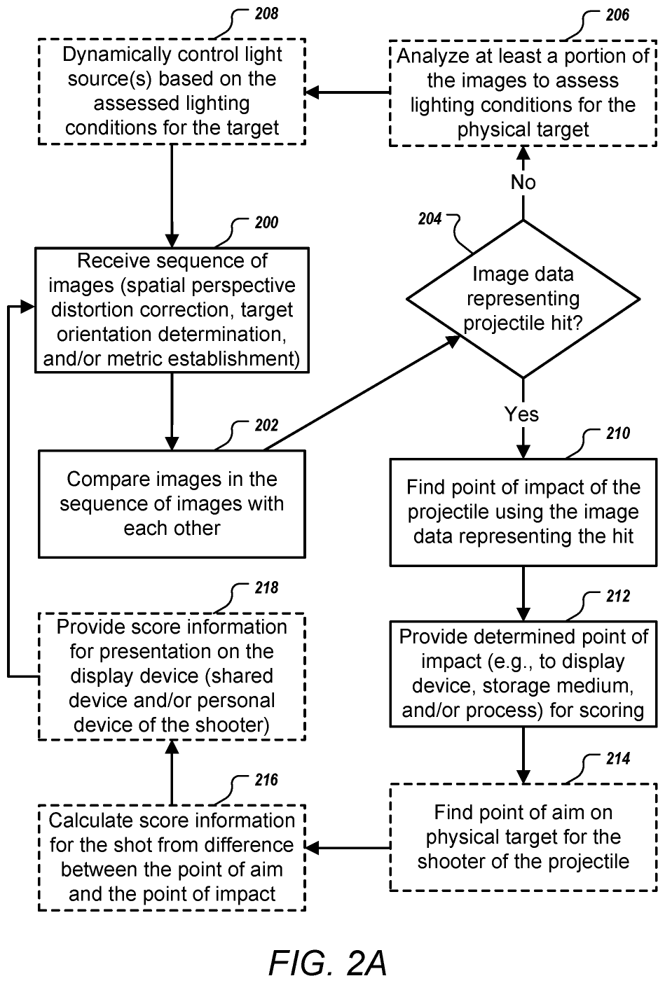

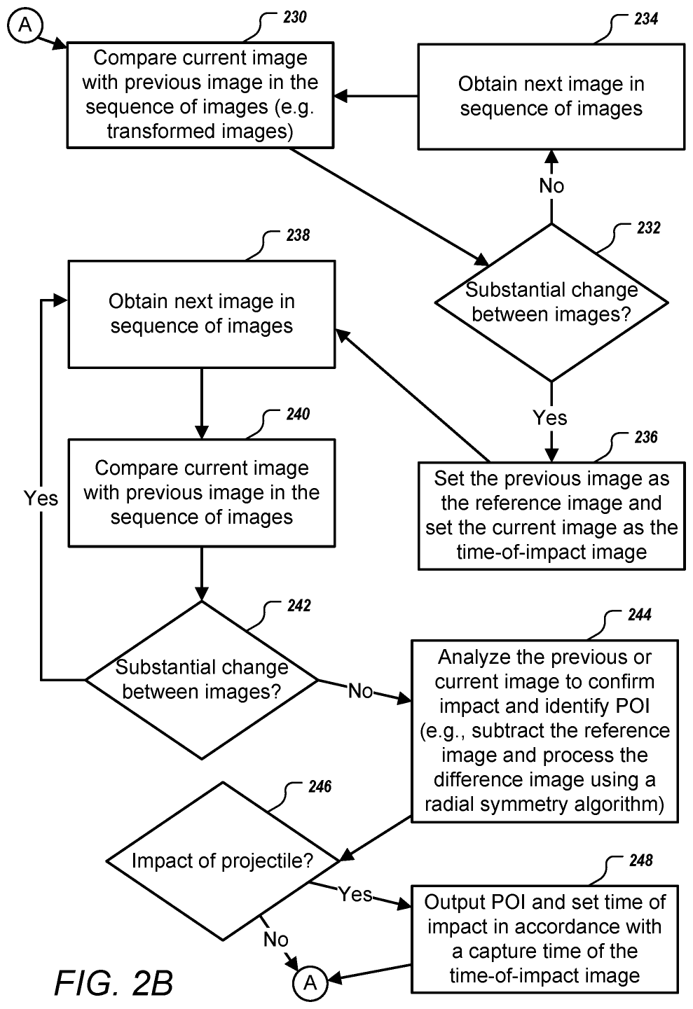

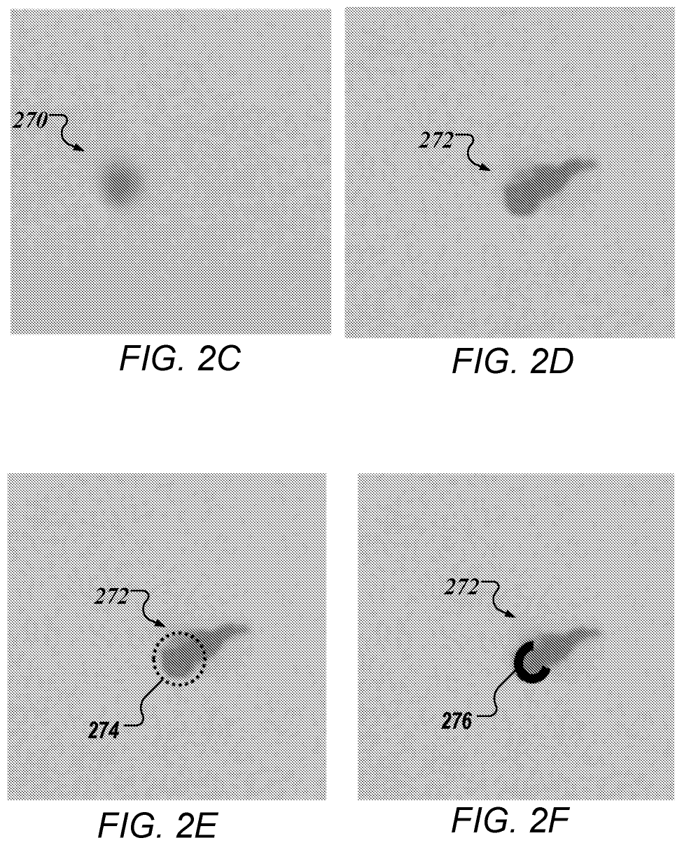

FIG. 2A shows an example of a process performed by one or more computers (e.g., one or more computers 140) to determine POI and, optionally, determine POA and perform shot scoring. Sequences of images are received 200. In some implementations, the images are passively received 200; in some implementations, the images are actively obtained 200 from a specified source; and in some implementations, the images are actively captured 200 using one or more cameras, e.g., camera(s) 130. In some implementations, the sequence of images are a continuous video stream from the camera.

In addition, the images can already have at least some spatial perspective distortion for the target corrected and/or the process can perform active correction of spatial perspective distortion. In order to provide sub-caliber precision using the image data, common lens aberrations should be corrected, and correction of “keystone” effect (also referred to as perspective control) should be provided. Keystone is the distortion caused by the object plane (e.g., a 2D target) not being parallel to the image plane of the camera sensor. In some implementations, a tilt/shift camera lens is used to remove keystone or perspective distortion effect at exposure time, which results in the same (or nearly the same) image spatial resolution across the target image. The tilt/shift of the lens can be adjusted at the time the camera 130 is positioned with respect to (e.g., attached to) the target 115. In some implementations, the system allows different size target frames to be attached with the camera 130 at different distances, which may require adjustment of the tilt/shift lens, e.g., adjusting the angle of the lens to ensure capturing of the full target area for image processing.

In some implementations, digital image processing is performed to provide the sub-caliber precision using the image data, e.g., the sub-caliber precision provides sub-caliber resolution (e.g., down to ½, ⅓, ¼, ⅕, 1/10, 1/20, or 1/50 of the bullet diameter/caliber) for the POI determination. This includes using digital perspective control transformation that adjusts the image so as to remove the keystone artifacts (note that this method does not recover the lost spatial resolution that occurs at the more distant portions of the target, e.g., the top of the target if the camera is located below the target, and so a tilt/shift camera lens can be used in combination with the digital perspective control) as well as using one or more other image distortion correction techniques, such as barrel distortion correction and pin cushion distortion correction (note that perspective correction is distinct from correction of lens aberrations). Lens distortions can be minimized using more complex lenses and can also be corrected with image processing using known techniques, such as the Brown-Conrady model. Further, note that the reference to diameter (caliber) of the bullet does not require a circular cross-section for the bullet, since the diameter (caliber) can also refer to bullets that are swaged to a polygonal shape (that is approximately, but not exactly circular) by a polygonal barrel of the gun. Moreover, the digital image processing described in this document can also be used to improve the resolution for the POA determination.

In addition, in some implementations, image processing techniques are used to correct chromatic aberrations caused by the lens focusing different colors to different locations on the camera sensor, which shows up as rainbow fringes on edges of image objects, and generally are more pronounced nearer the edges of an image. Also, in some implementations, the image data channels (e.g., red (R), green (G), and blue (B) color values per pixel) are treated as separate images for determining ballistic impact locations, and a separate set of lens distortion corrections is produced for each respective color image data channel, which can further improve the precision and accuracy of the system. Note that this can be extended to cameras with more than three color channels, such as an RGBW camera in which a 4th (white) pixel that is sensitive across the spectrum is used in addition to the three primary colors.

An RGBW camera can provide additional sensitivity outside the normal visible spectrum, particularly in the infrared (IR) range, which can result in further improvement to the precision and accuracy of the system. Machine vision cameras (as opposed to consumer or photography cameras) often remove the IR filter that is typically placed in front of the sensor. Using such a raw sensor (without an IR filter) as the camera can provide IR sensitivity that benefits the system's operation. An advantage of near IR (700-900 nm) is that one can use near IR illumination on the target to help create contrast. By taking alternate images with IR illumination on/off and comparing these images, the system's sensitivity can be increased. But using such IR illumination (whether flashing or constant) will not be a distraction to the shooter since the light is outside of the visible spectrum.

In some implementations, in addition to providing similar pixel resolution across the whole target image and improving the focus of the camera 130 on the target 115, use of a tilt/shift lens in the camera 130 can eliminate or reduce the need for an initial homography transform to correct most of the perspective distortion caused by the camera 130 not being directly in front of the target 115 (where it can't be, as this would place the camera 130 in the direct line of fire on the target 115). Eliminating an initial homography transform can speed up the image processing (e.g., by eliminating the need for a global homography transform on the images being processed to detect a change that indicates a hit) and allows easier reading of reference points, such as fiducials and ArUco markers (or other binary square fiducial markers, which can include 2D barcodes/matrix codes, such as quick response (QR) codes).

In general, various types of image processing can be performed 200. The image processing can be performed in response to the data in the sequence of images changing, e.g., when a new physical target is placed on the target stand and/or when a projectile hits the target, for each received image, or both. This image processing can include, in addition to spatial perspective distortion correction, determining an orientation of the target and establishing a metric for the target that relates pixel-to-pixel distance(s) in the image with distance(s) in the physical environment (i.e., the metric defines the relationship between real-world distance and image distance between locations on the target). The resolution of each image in the sequence depends on the number and spacing of the pixels in the camera's sensor array (e.g., the RGB values generated by the individual transducers of the camera's sensor array) onto which the lens projects an image of the physical target. Each pixel of an image corresponds to a square unit surface area on the physical target, i.e., object pixel size. The center-center distance between neighboring pixels is the pixel pitch and generates a corresponding object pitch. Therefore, for a given camera, lens, and object distance, there is a corresponding spatial resolution of the object given by the image of that object.

Respective images in the sequence of images are compared 202, e.g., in real time during a shooting session. In some implementations, each received image is compared with the previously received image. In some implementations, the respective images in the sequence of images that are compared 202 are a subset of images in a continuous video stream. For example, a proper subset of two or more images can be selected from the video stream (e.g., from a circular frame buffer) in accordance with timing determined by the one or more computers, e.g., based on timing for a shot determined using data from a radar system and/or an acoustic (microphone) system. However, in some implementations, the received images (e.g., in a video stream) are continuously processed in real time without any separate trigger for retrieving and processing images. Thus, continuous image acquisition and analysis can be used to automatically detect a change in the image that is consistent with a shot having hit the target, and real-time feedback (e.g., scoring) can be provided to the user of the system (e.g., the shooter and/or a competition official).

The images are compared 202 to identify image data representing a projectile having hit the physical medium of the target, e.g., data representing perforation of the paper of the target. Note that using cheaper materials, such as paper or other target media that are easily perforated by the projectile, can provide significant cost benefits for an integrated targeting and scoring system. However, this need not be the case in all implementations, e.g., the target can be a metal gong, and so the data need not represent actual damage to the physical target. In some implementations, the changed image data represents heat generated by the projectile having hit the physical medium, e.g., as a result of using an infrared camera to collect the image data, or as a result of visible light spectrum changes in the target caused by the heat generated from the friction and/or inelastic deformation caused by the impact of the projectile with the target.

For example, the camera(s) can include visible light camera(s), and the physical medium of the target can include an agent that changes an optical characteristic of reflected electromagnetic radiation in response to the heat generated by the projectile having hit the physical medium. The agent can include a thermochromic material that changes color when heated. For example, paper coated with fluoran leuco dye and Bisphenol A will change from colorless to, for instance, black when heated by friction caused by the impact of a bullet with the coated surface. Note that some thermochromic materials are reversible (they return to their original color when cooled back to the original temperature), while others are irreversible (the color change does not reverse upon cooling). An irreversible thermochromic coating on (or in) the physical target (e.g., using thermochromic paper) provides the benefit of retaining the thermal information created by the impact, providing a high contrast signature of the impact that allows analysis of the outer diameter of the impact site over a longer period of time. Finally, note that using changes in color need not be restricted to visible light, as cameras can record such changes in Ultra Violet (UV) or infrared regions of the light spectrum.

In the case of using an infrared camera, the camera can be responsive to electromagnetic radiation having a wavelength between 3 microns and 15 microns inclusive, e.g., 3-5 microns (mid-wavelength IR), 8-14 microns (long wavelength IR), or 8-12 microns, and the image data is produced by the electromagnetic radiation representing thermal contrast at, and around, the point of impact. When a shot strikes a target, energy is deposited at the point of impact causing the temperature of the target material to rise at the location of the strike. Additionally, the removal of the target material (e.g., the creation of a hole in the target material) can create a thermal contrast depending on the temperature and emissivity of the target material and the temperature and emissivity of the background beyond the target. By using a long wave infrared (LWIR) camera in the system, a wide variety of target materials (not just paper) can be used, and the thermal signature is less subject to confounding image artifacts such as target print (LWIR typically does not see the ink on a paper target), or insects or moving shadows, such as caused by motion of nearby trees in the wind or passing birds. Moreover, because the thermal signature of a shot dissipates quickly identifying following shots and determining their POIs will have less risk of being confounded by prior shots on the target.

Note that because an LWIR camera in general will be less sensitive to target print, the LWIR camera can be readily used as a shot trigger or shot detector. But a visible spectrum camera can also be used as a shot trigger or shot detector by continuously acquiring images and detecting when a new hole (or mark) appears on the target. Moreover, in some implementations, both a visual spectrum camera 130 and an infrared camera 130 are used together in the system, e.g., the visual camera can determine POA, and the infrared camera can determine POI. The correlation between the two camera images can be performed by a process where heat is generated at multiple visually identifiable points. For instance, a thin printed circuit board with an array of very small resistors, such as 0201 surface mount resistors, can be attached to the target surface, and an electrical current passing through the array can cause each resistor to heat. The IR images can then be correlated with the visual images of the array. Moreover, image homography can be used to correct perspective. For instance, the array images (e.g., in a square grid of known size) can be used for perspective correction for both IR and visible cameras.

In any case, processing 202 of the images can identify a change in the image data that may indicate that the physical target has been impacted by a projectile. A check 204 can be performed to confirm that the change in image data is in fact a projectile hit, and if so, the POI of the projectile can be found 210 using the image data representing the hit. This determined POI precisely represents the location on the physical target where the projectile has hit. In other words, it is not simply determined that the projectile has hit the target in some general area of the target, but rather the exact location of the hit (with sub-caliber precision) can be determined.

FIG. 2B shows an example of a process performed by one or more computers (e.g., one or more computers 140) of comparing images to determine a hit point (POI) on a physical target for a projectile. A current image is compared 230 with the previous image in the sequence of images. Note that the images discussed in connection with FIG. 2B can be images that have been transformed using image processing (e.g., using digital perspective control) as described in this specification, and this image processing and the comparison of images can be done in real time, as the images are received in the system. Also, in some implementations, digital perspective control is not used on the images initially, when first detecting a hit, but rather is used after an initial detection to confirm the hit, determine POI, or both. The process of FIG. 2B is an example of process operations 200-212 from FIG. 2A.

A check 232 is made to find whether there is a substantial change between the two images. For example, the data for a first image (the current image) can have the data for a second image (the previous image) subtracted 230 from it to create a difference image. Everything that is identical between the two images subtracts to essentially zero, so the check 232 can involve finding whether this difference image includes one or more pixels with values greater (or less) than a predefined threshold. If the difference image has pixel values that are essentially all zeros, then there is no substantial change, and a next image in the sequence of images is obtained 234 (and so becomes the new current image to be processed). In addition, the check 232 can involve requiring the difference image to include many pixel values (greater or less than the predefined threshold) that are within a predefined proximity to each other, e.g., as defined by distance (i.e., according to known bullet calibers) between the pixels and/or by the general shape formed by the pixels (i.e., forming a generally circular area). For example, the system can look for circular features consistent with a bullet hole that is between 4 and 12 mm in diameter. Note that the threshold and proximity requirements that establish a substantial change can be adjusted in various implementations to avoid failure to detect an impact, while also reducing the number of false positives, as determined by the processing that occurs each time a substantial change is found 232.

When a substantial change between consecutive images is found 232, the previous image is set 236 as a reference image for use in confirming a projectile hit, and the current image is set 236 as a time-of-impact image for later use if the projectile hit is confirmed. The next image in the sequence of images is then obtained 238 (becoming the new current image to be processed) and the current image is compared 240 with the previous image. A check 242 is made to find whether there is a substantial change between the two images. Similar to above, the data for a third image (the current image) can have the data for the image that immediately precedes it (this will be the time-of-impact image for a first pass through any loop 240, 242, 238 in the processing) subtracted 240 from it to create a difference image. Everything that is identical between the two images subtracts to essentially zero, so the check 242 can involve finding whether this difference image includes one or more pixels with values greater (or less) than the predefined threshold and (optionally) within the predefined proximity, as detailed above. In general, the checks 232, 242 determine whether many pixels in a local area change; isolated and dispersed pixels that change will generally not be considered a substantial change between images.

When a substantial change between the two images is found 242, a next image in the sequence of images is obtained 238 (and so becomes the new current image to be processed). This loop continues until no substantial change is found 242 between two consecutive images in the sequence, e.g., the difference image has pixel values that are essentially all zeros. Because there are no substantial changes between these two images, either the current image or the previous image can then be analyzed 244 to identify the POI. For example, the data for the current image (or the image immediately preceding the current image) can have the data for the reference image subtracted 244 from it to create a difference image, and this difference image can be processed 244 using a circular, rotational and/or radial symmetry algorithm, such as Hough Circle Transform (HCT) or Fast Radial Symmetry Transform (fRST), to provide sub-caliber precision in determining the POI. Note that a shot may strike the target during the image acquisition time, causing the image data from the time-of-impact image to be inconsistent with that of a typical shot due to debris, splatter and/or target movement; this is why the system waits for the changes in image data to subside, and the analysis 244 compares the previous or current image (taken after substantial image changes have stopped) with the reference image.

Using circular, rotational and/or radial symmetry process(es) to determine 244 the shot POI (and also optionally the POA) enables subpixel POI (and POA) precision. In some cases, a relatively precise location of the POI is needed. For instance, in small caliber competitions, it is estimated that the POI needs to be determined within approximately 0.1-0.2 mm. The typical caliber is about 5.5 mm, and a hole in the target paper can be about 4.5-5 mm is size (the paper stretches as the projectile passes through, then recovers (shrinks) back to leave a hole smaller than the projectile. It is typical to need POI precision substantially smaller than the caliber of the resulting hole. Also, shots on paper can produce irregular holes that do not appear perfectly round, making the determination of the true POI challenging. Moreover, the appearance of the hole can also include multiple shades or intensity that can confound locating the POI.

In general, to achieve 0.1 mm pixel resolution across an 17×11″ target sheet (without using the sub-caliber precision techniques described in this disclosure) would involve the use of 4318×2794 pixels at least, with distortions of less than 1 pixel. However, using the image analysis systems and techniques described in this specification, subpixel shot POI is possible with images having much lower pixel pitch (lower resolution) which facilitates real-time acquisition and processing of the images. Locating the centers of holes (POI) and target aimpoints (POA) to subpixel accuracy is significant since many scoring competitions require determining with high precision whether the outer edge of the shot's POI “breaks” a higher scoring circle, thereby determining the score. Thus, the present systems and techniques can be used in competitions where precision is paramount. Note that “high precision” here means that the image analysis achieves precision at a position precision of about 2% of the projectile diameter/caliber and/or precision at a level of about 4×10⁻⁵ of the target dimension.

In addition, using circular, rotational and/or radial symmetry processes (as described in this specification) to identify the true POI from the hole caused by the shot's impact on the target can also provide a circle that accurately corresponds to the projectile, even for irregular holes that do not appear perfectly round. Using this information, in some implementations, the system determines the caliber of the projectile since the size of the damage (hole+deformation+surface alternation) is related to the projectile caliber. Caliber is the inside diameter of the gun's bore, and also the ammunition's outside diameter, usually measured in inches, e.g., 0.22 (‘twenty two’), 0.30 (‘thirty’), 0.357 (‘three fifty seven’), 0.45 (‘forty five’), and 0.50 (‘fifty’) inches, or measured in millimeters, e.g., 5.56 mm (‘five five six’), 7.62 mm (seven six two), and 9 mm. Differences between the hole size and the bullet size that are a result of recovery (shrinkage) of the target material after the projectile has hit the target can be accounted for. In some implementations, the system can estimate the caliber of the round by assessing the best fit amongst candidate calibers.

FIGS. 2C-2F show examples of images of holes formed when projectiles hit paper. As shown in FIG. 2C, a formed hole 270 may be mostly round like a circle. For such holes, various techniques, such as a Hough Circle Transform (HCT) or a center-of-mass calculation, can be used to find an accurate center of the hole. However, many projectile holes in targets do not have such a round, mostly circular shape.

FIG. 2D shows a formed hole 272 that is irregular and not round. FIG. 2E shows a circle 274 around a portion of the hole 272, where the circle 274 corresponds to where the bullet actually hit the target. Note that the hole 272 has a shape that is often referred to as a “keyhole”, which can be quite common, depending on various factors, such as the ammunition type, velocity of the bullet, and the nature of the target paper. Typically, a triangular section of the target paper tears away (up and to the right in the example shown) leaving behind a shape 272 for which a center-of-mass calculation will provide an incorrect POI and the HTC algorithm will likely provide an inaccurate POI or no POI at all.

To address this issue, a radial symmetry algorithm, such as that described in Zelinsky, Alexander and Loy, Garreth, “Fast Radial Symmetry for Detecting Points of Interest”, IEEE Trans. on Pattern Analysis and Machine Intelligence, vol. 25, pp. 959-973, August 2003, which is also referred to as fRST, can be used. This type of radial symmetry algorithm is better at finding the true POI for the bullet holes, regardless of whether or not they are keyholed, and is computationally fast, which provides benefits in terms of accuracy and real-time results for the system.

The fRST algorithm heavily weights points in the image that have high radial symmetry. As shown in FIG. 2F, for the hole 272, a portion 276 of the hole 272 is a circular section that is much more important for finding the true POI. The portion 276 is an arc, and the center of this arc is the true POI. Note that in the HTC method, an edge detector is used to find edges of features; points on edges are allowed to vote for all points a certain radius away from them. In the fRST method, all points are allowed to vote, but (1) given a number of votes in proportion to their intensity gradient, and (2) allowed to vote only in the direction of that gradient. Further, the fRST method has a second element that weighs how many different pixels vote for a given pixel—it is better to receive 10 votes from 10 different voters than 10 votes from 1 voter. This feature reinforces circularity.

Using a radial symmetry method, such as the fRST method, the POI determination can weight features in an analog/continuous manner, i.e., in proportion to intensity gradient; all pixels have votes, but in proportion to their feature value. This is advantageous as compared to using binary detection (using predetermined binary or thresholded features) to determine the POI. Such radial symmetry methods can also generate many fewer votes on a point-by-point basis; they do not spread lots of votes around meaning less overall noise. Such radial symmetry methods can be configured to always generate a relevant answer, rather than failing to identify a POI in some cases of very oddly shaped holes, thus providing robustness/reliability for the system. In some implementations, additional processing can be performed to determine how circular the hole 272 is, thus providing an evaluation of how reliable the POI determination is. Finally, as noted, such methods are fast, which facilitates real-time shot scoring.

Returning to FIG. 2B, in some implementations, the analysis 244 includes image analysis that confirms the change in image data represents a projectile's impact on the target, rather than an image data change caused by some other event. An insect or other cause of the image data change can initially trigger the check for a projectile impact, but further analysis 244 can determine whether the image artifact is not a valid impact (and so is discarded) or is a valid impact (and so POI is confirmed). In some implementations, this further analysis 244 involves using the very same radial symmetry method, e.g., fRST, used to determine the POI. By analyzing 244 the output of the radial symmetry algorithm, other confounding image artifacts (e.g., from a fly or a piece of dirt landing on the target) can be readily excluded as not being bullet holes.

For example, in some implementations, the difference image is processed using fRST, which assigns a value to each pixel; the higher the value for a given pixel, the more likely it is that pixel is the center of a bullet hole. If an artifact is a bullet hole, then many pixels will be found near the center of the hole with high values. A weighted average can be used to determine the center, and so the center can be a point between pixels (i.e., sub-pixel precision). But if the highest values are found dispersed over the image (i.e., the highest values are not localized) then the processing 244 can determine 246 that there is no hole despite the original threshold being exceeded at 232.

Note also that the processing 244 of the difference image by fRST (or another radial symmetry algorithm) can involve processing one or more portions of the difference image, as selected by the “blob” detection performed at 232; isolating one or more sections of the image to process using a radial symmetry transform reduces the amount of computational resources that are needed and so improves real-time performance. For example, using the blob detection 232 and limiting the regions of the image that are processed 244 can reduce the computational requirements by well over 90%. In any case, when the image data is confirmed 246 as representing a projectile impact with the target, the determined POI is output 248 before the process continues comparing 230 images to identify a next projectile impact.

Also, in some implementations, the time of the determined projectile impact is set 248 in accordance with a capture time of the time-of-impact image. This can involve using a timestamp of the time-of-impact image directly, or in combination with other data indicating the time of impact (e.g., from radar and/or microphone sensor input analysis) to determine the time of the impact with high precision, e.g., within one tenth of a second, one twenty-fourth of a second, one thirtieth of a second, or one sixtieth of a second. Note that determining the time of projectile impact can be useful for several reasons, including in a competition, where the system can determine whether a shot was taken within the specified competition time limits.

In some implementations, a microphone 137 at the shooting bench is used to detect the muzzle blast of a shot and provide the time that the shot is taken with millisecond precision. A microphone located at the bench(es) allows the system to coordinate the gun discharge with the arrival of a shot at the target. This information can be used to assess when cross-fires occurs. Rifle muzzle velocities are between 500 fps (air rifles) to over 3000 fps (centerfire rifles). At a range of 25 yards, the transit time is between 25 msec and 150 msec.

Returning to FIG. 2A, in some implementations, active lighting control is used for the target, e.g., to ensure that changes in environmental lighting (such as from clouds passing in front of the sun in an outdoor system) do not trigger false impact detections by the system. For instance, the target can be divided into multiple sections, and average brightness can be measured for each section and be compared to each other. Thus, at least a portion of the sequence of images can be analyzed 206 to assess lighting conditions for the target. The light source for the target (e.g., light source 165 in FIG. 1A, e.g., white LEDs 165) can then be dynamically controlled 208 based on the assessed lighting conditions to improve lighting intensity and uniformity on the target. For instance, if a shadow is cast over the target due to local obstructions, the lighting system can provide fill-in lighting to decrease the contrast on the target seen by the shooter caused by the local obstructions that cast shadows on the target. Using variable lighting to dynamically induce imaging artifact contrast can involve actively changing the lighting by altering color or wavelength components and/or spatial lighting angles at the time of image acquisition. Multiple images can be acquired with each lighting condition. For instance, an image of the target can be acquired under vertically polarized illumination, followed by an image of the target under horizontally polarized illumination. Together, these images can be combined mathematically to achieve an image that contains greater contrast than either individual image by itself.

Also note that the dynamic lighting control can be done when no projectile impact is detected, and also when a projectile impact is detected. Using variable lighting to improve image artifact contrast can facilitate acquiring 3D shape information, which can improve the POI determination precision; note that when a paper target is impacted by a bullet, it is typical for the paper in the immediate area of the impact to be deformed and displaced (often leaving an inverted partial dome or dimple) and much higher contrast for such artifacts can be achieved using the systems and techniques of the present application as compared to using a flatbed scanner (on a paper target that has been removed from the range while in a “cold” state) which only provides flat illumination and so has low contrast for such induced 3D shapes. For example, the target can be illuminated from different angles to produce different levels of contrast and to emphasize different features of a bullet hole.

Further, when a projectile impact is detected 204, and the POI is found 210, information regarding the determined POI is provided 212, e.g., for scoring. This can involve providing the determined POI to a display device, to a non-transitory storage medium, and/or to another process for use in scoring the shot. In addition, the score and optionally the POI and the POA can be determined and presented on a display device, e.g., one or more of display devices 150, 155 in FIG. 1A.

In some implementations, the POA on the physical target for the shooter of the projectile is found 214, score information for the shot is calculated 216 from the difference between the POA and the POI, and the score information is provided 218 to a display device, to a non-transitory storage medium, and/or to another process for use in presenting the score information on a display device, e.g., one or more of display devices 150, 155 in FIG. 1A. The score information can include the value assigned to a shot's POI based on shot error and/or simply a “hit” or “miss” determination, but in many implementations, the scoring provides an objective evaluation in the form of a numerical value that assesses the accuracy of a shot or a series of shots on a target. In some implementations, the score decreases as the radial distance of the POI from the POA increases for each respective shot (e.g., based on the POI distance from the center of each respective bull on a physical target).

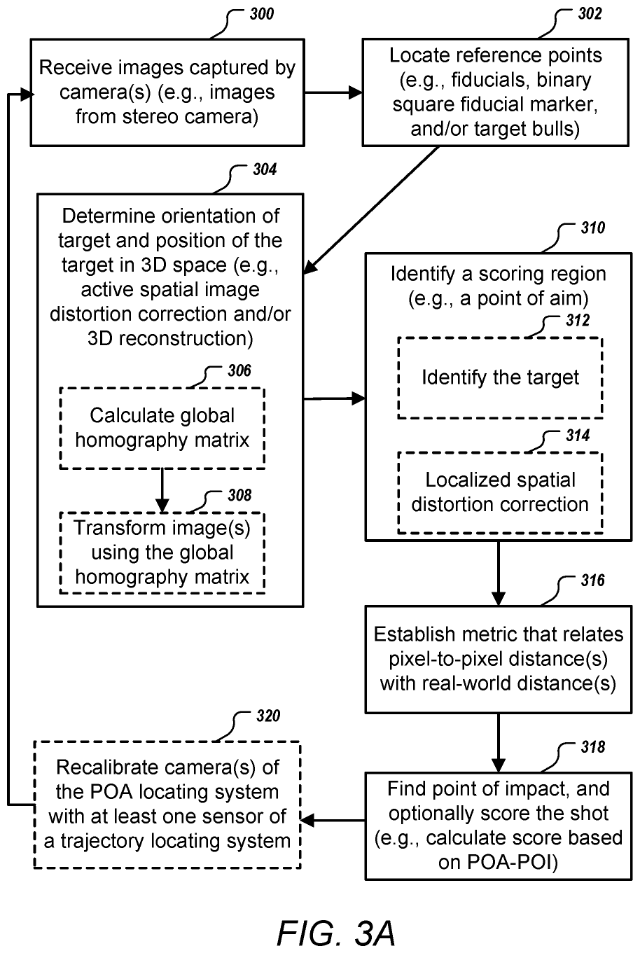

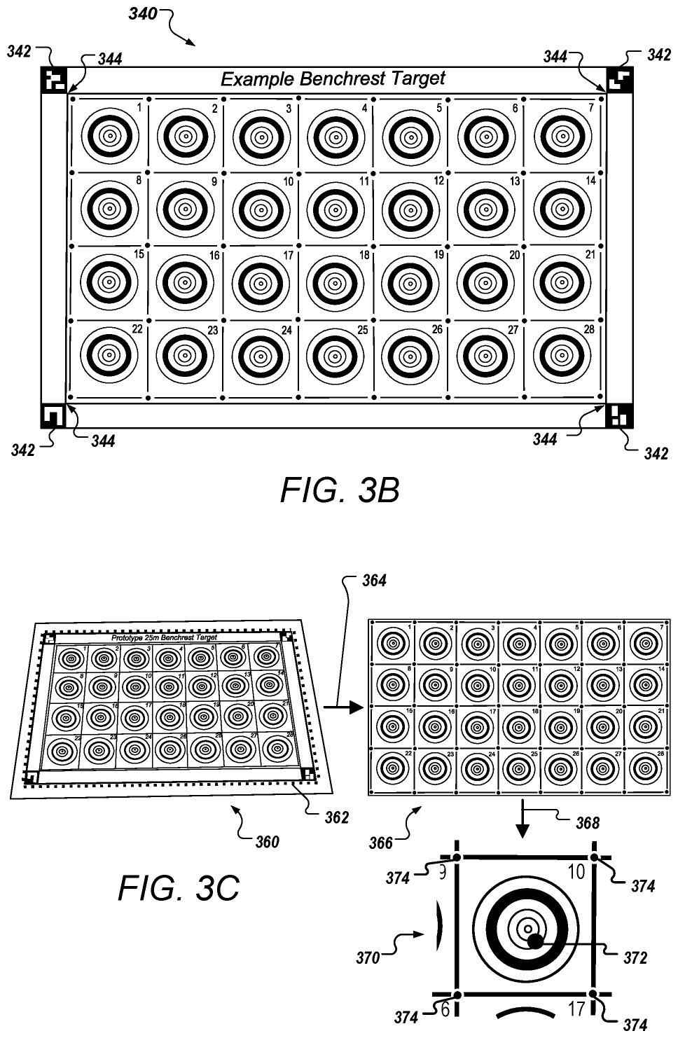

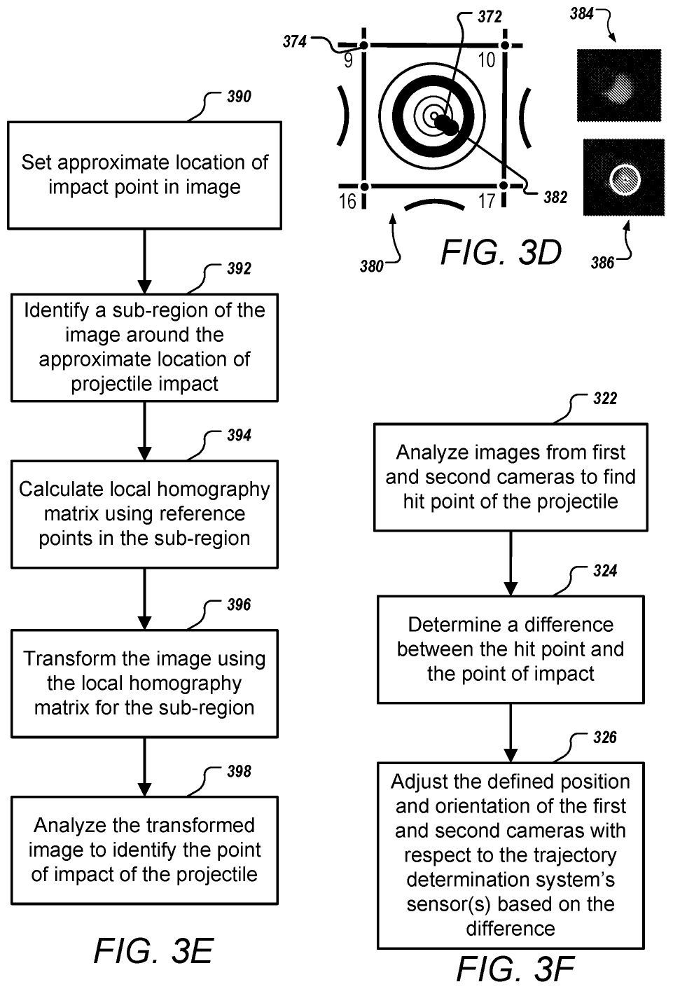

FIG. 3A shows an example of a process performed by one or more computers (e.g., one or more computers 140) to determine POI with respect to a scoring region or POA, and optionally perform shot scoring. The process of FIG. 3A can be integrated with the process of 2A in some implementations, where image data (from the camera) is used to determine POI and the scoring region or POA. In some implementations, image data (from a camera-based target viewing subsystem) is used to determine the scoring region and/or POA, and data (from a trajectory locating subsystem) is used to determine POI in accordance with a position and orientation of the target determined from the image data.

Images are received 300 that have been captured by one or more cameras. In some implementations, the images are passively received 300; in some implementations, the images are actively obtained 300 from a specified source; and in some implementations, the images are actively captured 300 using one or more cameras, e.g., camera(s) 130. In some implementations, the sequence of images are a continuous video stream from the camera. In some implementations, the camera is a stereo camera (first and second cameras viewing the same object from different perspectives) and the images are paired images from the stereo camera, which can provide a continuous video stream of paired images.

Reference points are located 302 in the images using image processing techniques. Various types of reference points can be located 302 including fiducials placed on the target (e.g., fiducial reference points placed around a target bull), one or more binary square fiducial markers (e.g., one or more ArUco markers), and/or target bulls placed on the target. The locating 302 involves extraction of image features that correspond to specific artifacts of interest. Target bulls can be located 302 by identifying concentric circles in a received image, binary square fiducial markers can be located 302 by identifying the predefined shape of the marker type (and its encoded data) in a received image, and fiducials can be located 302 by identifying dots in the image that are placed around a target bull in a known pattern. In any case, image analysis is performed on the received images to locate at least three or four reference points, and more reference points can be used in some implementations. In addition, when the target is a 3D target (e.g., with a depth dimension larger than a sheet of paper) the image analysis 302 can include finding matching points in respective images from the two cameras of a stereo camera, where these matching reference points can be defined points on the 3D target, which need not be predefined fiducials, markers or bulls.

Using the reference points, an orientation of the target is determined 304. This can include calculating 306 a global homography matrix for the target using at least four reference points, e.g., using the four corners of an ArUco marker or using more than one ArUco marker, and transforming 308 the images using the global homography matrix to correct spatial perspective distortion caused by the object plane of a physical medium of the target being non-parallel with the image plane of the camera. Note that the target (e.g., a target sheet) may not be placed precisely relative to the camera, and so the target position may not be known relative to the image field. But reference points (e.g., fiducials, one or more binary square fiducial markers, etc.) can be used to determine approximate target locations within the field of view of the camera, e.g., based on a priori knowledge of one or more target aimpoints and/or based on image processing to identify one or more target aimpoints. Moreover, image analysis on smaller sections of the full image can accelerate refinement of target aimpoints.

The homography correction can be done 306, 308 independently for each respective image from a stereo camera and/or for each respective color data channel. In addition, while some form of spatial distortion correction is needed in most implementations to achieve the desired precision for POI, an initial, global homography correction of perspective errors may not be needed when tilt/shift camera(s) are used, since the tilt/shift camera(s) eliminate most of the perspective distortion, and the necessary precision can be achieved using localized spatial distortion correction in an area of the image around a detected hit.

In general, the target impact detection system should employ some form of homography perspective correction because it is necessary to position a camera off the normal to the center of the target, and the amount of offset is such that a typical camera must be rotated in order to image the whole target, resulting in the target surface and image sensor not being parallel (thus a rectangle is imaged as a quadrilateral), and because a precise positioning and orientation of the target cannot always be ensured. Perspective correction via a homography transform is the most significant correction to be made in practice. A homography transform is done by applying a 3×3 homography (H) matrix to the image. Each pixel (x,y) is moved it to its (correct) location (x′,y′) using matrix multiplication:

$$[ \begin{matrix}{x}^{′} \\ {y}^{′} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & 1\end{matrix} ] [ \begin{matrix}x \\ y \\ 1\end{matrix} ]$$

This H matrix is has 8 degrees of freedom (h₁₁, h₁₂, etc.). To determine H, eight 8 knowns are needed, which are obtained from the two known coordinates (x,y) of four different reference points within the image. Once calculated, this homography operation rotates, stretches, skews, and scales images to be correct.

In any case, in order to produce highly accurate POI determinations using ballistic image analysis, sufficient image corrections should be applied (both correction of perspective errors and of lens-induced aberrations) to make straight lines appear straight, parallel lines appear parallel, and object shapes appear correct. In other words, the corrected image needs to be a rectilinear projection (i.e., an undistorted image) of the target surface with known scaling factor(s) (e.g., number of pixels per mm along each axis; the scale factor along x need not be the same as along y). This will allow photogrammetry to take place, where the POI is accurately located with respect to the POA in real world units, thus enabling real-time, accurate scoring.

In some implementations, the determining 304 is done for each image received (to catch changes in target placement resulting from wind or another force) or after a shot is detected (to catch changes in target placement resulting from the projectile's impact). Thus, the determining 304 can be redone after each shot by the shooter on the target. Furthermore, determining 304 the orientation of the target can include determining whether the target is upside down or at some other non-standard orientation. Note that if the target is mounted at a 45 degree angle, or even upside-down, the H transform discussed above can correct it. The user of the target system therefore does not need to carefully mount the target (e.g., a sheet of paper) level or at a specific location or orientation since the homography transform will rotate the image as well as correct perspective. This capability of the system provides significant ease of use since accurate and precise locating of the hits/impacts on the target can be achieved (e.g., for competition scoring) even when there are minimal controls in place for getting the target into an expected position and orientation, as the system can automatically determine the orientation of the target and correct spatial perspective distortion caused by the camera viewing the target from an angle.

In addition, in some implementations, the orientation determination 304 is performed using one or more binary square fiducial markers, such as ArUco markers. FIG. 3B shows an example of a benchrest target 340. At the four corners of the target 340 are Aruco markers 342. Each Aruco marker 342 is encoded with a specific number that allows the system to identify which corner of the target 340 is the upper left corner, the upper right corner, etc. The image processing code can locate the inside corners 344 (closest to center of image) or other corners of each marker 342, and since the real coordinates of these points 344 on the target 340 can be known in advance (e.g., based on identification of the target as one that was created previously and then printed for a given shooting even) these four reference points 344 can be used to calculate a homography transform to do a global correction of perspective for the target 340.

Other configurations can be used for various targets. For example, some implementations use only a single ArUco marker (or similar binary square fiducial marker) where the four corners of the single fiducial marker can be used to calculate a homography transform. However, using reference points that are far apart in the image can improve the accuracy of the homography transform. Also, some implementations include no binary square fiducial markers, and the target bulls themselves (28 target bulls are shown in the example of FIG. 3B) and/or fiducials associated with one or more of the target bulls on the target can be used to calculate a homography transform. This is advantageous since the printed image on a target often does not register precisely with the physical edges of the target sheet.

In some implementations, the system is programmed to use various image processing techniques to identify various types of image artifacts that can be used for perspective distortion correction and to identify a POA. This makes the system more flexible in that many different targets can be used with the system, including targets that the user designs and prints independently, provided there is at least one bullseye with at least four fiducial points placed around the bullseye (e.g., fiducials printed on a 2 inch grid around each of the bulls).

Returning to FIG. 3A, in some implementations, the determining 304 includes determining both an orientation and a position of the target in 3D space with respect to the camera(s) used to capture the images being processed. For targets that are essentially two dimensional (e.g., a sheet of paper with the target elements printed thereon) the determination 304 of position and orientation in 3D space is useful for combining POA (and optionally POI) from a camera-based target viewing (and optionally impact detection) subsystem with projectile path data from a trajectory locating subsystem to find (and optionally reconfirm) the POI. In addition, the target can be a three-dimensional target, and the determining 304 can include performing 3D reconstruction of the target (from images from a stereo camera) in accordance with epipolar geometry (of the stereo camera) to produce a three-dimensional model of the three-dimensional physical target. For example, the 3D target can include reference points (e.g., fiducial marks) at known locations, and the system can use those reference points found in stereo camera images to calculate both a pose of the stereo camera with respect to the 3D target and a depth distance of the 3D target from the stereo camera.

Note that determining 304 the position and orientation of the physical target in 3D space with respect to first and second cameras of a stereo camera pair requires at least three reference points that are not all colinear. The system can determine (x, y, z) coordinates of at least three non-colinear points of the target to locate that target in 3D space. But while only three reference points are needed, in practice, using more reference points can improve the accuracy of the registration of the target in 3D space by the stereo camera.

A scoring region and/or POA is identified 310. In some implementations, this involves identifying the target 312, and then using known information about the identified target (e.g., pulled from a database) to determine which image artifacts to look for that will correspond to a particular scoring region and/or POA for the target. Identifying 312 the target can involve decoding data included in one or more binary square fiducial markers (e.g., one or more ArUco markers) and/or performing optical character recognition (OCR) on alphanumeric data included on the target. In some implementations, the target is a 3D target, and identifying 312 the 3D target involves comparing a three-dimensional model of the 3D target (reconstructed from stereo camera image data) to different three-dimensional models of various targets in a database of predetermined targets. In some implementations, identifying 310 the scoring region and/or POA can involve using image processing techniques to find 310 one or more aimpoints using circular, rotational and/or radial symmetry image analysis of image features that are larger than the caliber of a bullet, e.g., one or more bull on the target can be found by identifying 310 concentric circles in an image of the target.

Furthermore, identifying 310 the scoring region and/or POA can include using localized spatial distortion correction 314 to precisely locate a POA in 3D space. Note that a target can include multiple sub-targets (e.g., different scoring areas, bulls on a target sheet, or features of interest on a 3D target) and the system can be configured to select a next sub-target and provide information regarding the next sub-target to the display device 150, 155 for the shooter. In some cases, the position of each sub-target on the target is known a priori based on the known design for the target, and the order of selection of the sub-targets may be specified by the rules of a particular shooting competition or scenario. In some cases, the position of each sub-target on the target is not known a priori, and the system is configured to identify all the likely sub-targets on the target and then select an order for them. In some cases, no specific order of shooting on the sub-targets (elements of the target representing separate aimpoints) is required.

A metric is established 316 that relates one or more pixel-to-pixel distances with one or more real-world distances in the physical environment of the target, i.e., the metric defines the relationship between real-world distance and image distance between locations on the target. This can involve using the one or more homography matrices discussed above. In addition, there can be an overall scale factor, and the corrected image can be scaled up or down to achieve a desired pixels per unit length, e.g., scaling to achieve 225 pixels per inch. In general, each pixel in an image corresponds to some distance in the real world, and the coordinates of an impact are determined relative to some known feature, e.g., a point of aim. The point of impact is found 318 using the systems and techniques described in this application, e.g., using the processes described above in connection with FIGS. 2A & 2B.

In some implementations, active spatial image distortion correction is performed both globally and locally, and the local spatial distortion correction can ensure that the POI determination 318 can achieve the desired accuracy without requiring that the target be registered (accurately positioned or precisely known). For example, the localized spatial distortion correction can be performed for each image in the sequences of images processed using the techniques described above in connection with FIG. 2B, and so even unpredictable movement of the target caused by the impact of the projectile itself (or other forces, such as wind) can be accommodated. Thus, there is no need to rely on a calibrated placement and orientation of camera and target (with respect to each other) before acquiring and processing image data.

FIG. 3C shows an example of global and local perspective distortion correction for the benchrest target of FIG. 3B. A first image 360 shows the raw image from the camera, where the target 340 has been mounted with a very slight rotation to the left. Also shown is a trapezoid shape 362 of the target, which is detected by the system using the ArUco markers 342. The H transform corrects 364 both the perspective distortion as well as the rotation, as shown in a second image 366, which is the image resulting from the global perspective distortion correction. Thus, in this example, the global perspective distortion correction is performed using a first set of four reference points in the image.

When a shot on the target is detected, e.g., by a blob detector that operates continuously in real time, such as discussed above in connection with FIG. 2B, the relevant portion of the image can be further processed to perform local perspective distortion correction, thereby providing a very accurate determination of POI. FIG. 3E shows an example of a process performed by one or more computers (e.g., one or more computers 140) to provide localized active spatial distortion correction. An approximate location of impact is set 390 as a point within the image data (e.g., the approximate hit point can be the center of mass of the change feature found in the difference image between the reference image and the current/previous image discussed above in connection with FIG. 2B). In the example of FIG. 3C, the shot is detected in box #10.

Using the approximate location of impact, a sub-region of the image is identified 392, where the sub-region fully contains the approximate location of impact and at least four reference points around the approximate location of impact. As shown in FIG. 3C, a sub-region 370 of the image 366 is selected 368 in accordance with the detected blob 372, which may not yet be confirmed as a bullet impact at this point of the processing. Note that box #10 has four circular dots 374 around its bull, which are the fiducial marks that are shared among the aimpoints of boxes 3, 9, 10, 11 & 17. These fiducials 374 are a second set of four reference points that are used for the local perspective distortion correction. The selection/identification 368/392 of the sub-region can be based on a known size of the target and its aimpoints (e.g., fiducials printed on a 2 inch grid) and/or based on image processing (e.g., locating the dots 374 using circular, rotational and/or radial symmetry processing) to ensure that the local reference points are in included in the image data used for the next stage of the processing.

A local homography matrix is calculated 394 using the at least four reference points (e.g., bull fiducials) located in the sub-region (e.g., in a visible wavelength image corresponding to the current/previous image, which can be a visible wavelength or an infrared image). In some implementations, this involves forcing the transform to dimensions that are known for the reference points. For example, a new H matrix can be calculated to force the four fiducials 374 surrounding box #10 in FIG. 3C to lie exactly on the corners of a 2 inch square. This enforces a correction that is more accurate locally than the initial, global H correction, and can serve to reduce the need for other image distortion corrections. For example, forcing a localized H transform to match predefined dimensions for the local reference points on the target can eliminate most of any pincushion effect present in the original image.

Moreover, it should be noted that an actual correction 364 is not explicitly needed for the entire image. In some implementations, the global H matrix (which can be accurate to approximately 2 mm) can be used to grab a small region around each of the four reference points 374 and around the presumed bullet hole 372, with enough margin to ensure none of these five features is missed. Thus, the identification 392 of the sub-region can involve identification 392 of five separate sub-regions: one region for the presumed bullet hole 372 and one region for each of the four fiducials 374. Then, the system can correct and analyze only those five, small sub-regions to arrive at the POI, which reduces the amount calculations needed dramatically, thus further facilitating real-time shot detection and scoring.

At least some of the image data of the sub-region (e.g., at least the small region around the presumed bullet hole 372) is transformed 396 using the local homography matrix to produce transformed image data with reduced or eliminated local spatial perspective distortion. The transformed image data is then analyzed 398 to identify the POI using the systems and techniques described in this disclosure. In some implementations, this POI from the image analysis is used directly in scoring. In some implementations, this POI from the image analysis is used to calibrate at least one sensor of a trajectory locating system/subsystem.

Additionally, in some implementations, the system is designed to detect overlapping shots. FIG. 3D shows an example of detecting an overlapping shot for the benchrest target of FIG. 3B. A sub-region 380 of the original image is selected in accordance with a detected blob 382. Note that the blob 382 overlaps the prior shot 372, and so the sub-region 380 is basically the same as sub-region 370 from FIG. 3C. However, the two sub-regions 370, 380 are not identical since they are from images of the target taken at different times, and the target may have moved, e.g., as a results of the first shot hitting it.

But in this example, the first shot's mark is still on the target (i.e., the first shot's mark on the target was not a temporary heat signal) so a difference image 384 shows a crescent shape for the blob, rather than a circular shape. Using the fRST method to analyze the data of the difference image, the points with high radial symmetry, e.g. points that are centers of circular features, are detected. As shown in the image analysis results 386, the twenty highest “vote getters” from the output of the fRST method are the dots in the middle, and a circle that is centered on the average of those twenty highest “vote getters” is the determined POI. Note that the crescent shape of the overlapping shot does not prevent the system from accurately finding the true POI for the overlapping target hit using the image analysis process.

Returning to FIG. 3A, in some implementations, the shot is scored 318 based on the point of impact and a scoring region or the POA. The scoring 318 can involve determining whether the POI is within the area of a particular scoring region (hit or miss determination) as well as assigning different points based on the particular scoring region (e.g., based on difficulty). In addition, the scoring 318 can involve subtracting POI from POA (shot error calculation). Note that simply determining the location of an impact feature within an image may not be sufficient for scoring, which may require finalizing this POI location in the real world. In some implementations, the camera position and orientation are known or fixed relative to a target surface, e.g., by calibration at the time of setup-knowing the distance from the camera to the target, knowing the camera lens characteristics, and using geometry to calculate the metrics for determining POA, POI, or both accurately in real world distances, e.g., mm, inches, etc. For example, a stereo camera can be placed in a fixed position, and the location of the target relative to the stereo camera (and thus the captured images) is ascertained/calibrated. However, in such implementations, if there are subsequent changes in the camera/target physical relationship, such as from thermal expansion or other movement, the subsequent measurements will fail to account for those changes and the results will have errors. If targets must be mounted after setup, then those targets must be placed accurately into predetermined positions or suffer resulting errors.

Using the metric establishment techniques described in this disclosure, i.e., using known image artifact (such as fiducials) to develop a metric during the image analysis process avoids these problems associated with a fixed relationship between the target and the camera, and in some cases, requires no prior knowledge of the target as printed. Thus, image analysis alone can provide the correct metric information at the time of the shot to accurately locate the target POA and POI in real world coordinates for precise scoring 318. Nonetheless, even though no other information regarding the shot is needed for scoring, in some implementations, a trajectory locating system is used to determine the path of the projectile in 3D space for use in finding the POI, while also exploiting the ability of the imaging system to provide high precision.

In some implementations, the camera position and orientation are known with respect to at least one sensor of a trajectory locating system/subsystem configured to generate data usable to determine a three-dimensional path of the projectile shot from the gun, e.g., a bullet trajectory, and the POI is found 318 in accordance with an intersection of a three-dimensional path (located in 3D space by the trajectory subsystem) with the physical target (located in 3D space by the target locating subsystem using the camera(s) 130). The intersection can be established using the determined position and orientation of the physical target with respect to the first and second cameras, and using the defined position and orientation of the first and second cameras with respect to the at least one sensor of the trajectory system/subsystem. In addition, in some implementations, active recalibration of the target locating subsystem (which identifies the POA on the target) with the trajectory subsystem is performed 320.

Using the systems and techniques described in this application, the target locating subsystem can find the POI in addition to the target itself (and optionally one or more scoring regions or POAs). This POI determination can thus be used as a check against the POI determined using the projectile path determined by the trajectory subsystem. FIG. 3F shows an example of a process performed by one or more computers (e.g., one or more computers 140) to provide in-the-field calibration of a target locating system with a trajectory locating system.

A sequence of images from at least one of the first and second cameras is analyzed 322 to find a hit point of the projectile on the physical target (i.e., the POI determined by the target locating system). This process can involve using the various techniques described in this disclosure. A difference between the hit point (the POI determined by the target locating system) and the point of impact (the POI determined using the 3D path determined by the trajectory locating system) is determined 324. Then, the defined position and orientation of the first and second cameras (of the target locating system) are adjusted 326 with respect to the at least one sensor (of the trajectory locating system/subsystem) based on the difference between the hit point and the point of impact.

This in-the-field calibration can provide significant improvement in the accuracy of an electronic target scoring system, which finds bullet hole locations relative to the target. Such a calibration can use a series of shots spread across a detection region to determine the precise position (3 coordinates) and orientation (3 angles about each axis) of each camera, and also account for imprecision in lens focal lengths (a 1% error in focal length is a 1% error in magnification, and that can mean ˜10 mm error in actual location). Note that camera boards are installed within the camera with typical errors of 0.1 mm to 0.2 mm—that is 5-10 mm error in position in the image. The optical axis is meant to pass through the center of the image sensor but typically is 2 to 3 pixels off. That makes no difference in image quality for typical users, but if this is not corrected in a target scoring system, the result can 10 mm of error. Using the calibration technique described herein, rather than assuming the cameras and the mounting of the cameras are exact, these small errors can be detected and accounted for, e.g., using the series of shots spread across the detection region and a numerical optimization routine. As a result, average errors of less than 1.5 mm can be readily achieved for determining the location of the target (and thus of each bullet hole in the target) relative to the sensor system used to detect the bullet holes in the target.

In addition to military and police use, the described systems and techniques can be used in a number of applications, including as a commercial target system for recreational and competitive shooting sports. Shooting sports are a widely enjoyed recreational, and competitive activities embrace many forms of marksmanship. Both recreational shooting as well as organized disciplines would benefit from a low cost, adaptable electronic point-of-impact/scoring system. Adaptability is an important attribute of such a technology as it should support and be scalable to such diverse applications as 1000 yard F-class centerfire, rimfire benchrest at 50 yards, Bullseye pistol at 25 and 50 yards, or 10 meter air rifle/pistol.

A precise, real-time target system would have many benefits. It would enable more precise scoring with much less manual effort, allow for greater spectator involvement and excitement, and lead to increasing popularity. A precise and low cost system would allow smaller clubs, ranges, and individuals to access precise and real-time shot placement information for sighting in, load development, testing and characterization, practice, and informal or local competitions. In turn these lead to greater interest and growth of the shooting sports with follow-on advancements in equipment and techniques. Law enforcement training and qualification can benefit by better and automated shot location detection. Greater enjoyment of shooting benefits civilian marksmanship, promotes stewards of safety and advocacy, advances a camaraderie that enhances the family environment, and increases the confidence, self-discipline, and self-esteem of youth.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. Thus, particular embodiments of the invention have been described. Other implementations are also possible.

### EXAMPLES

Although the present application is defined in the attached claims, it should be understood that the present invention can also (additionally or alternatively) be defined in accordance with the following examples:
Example 1. A system comprising:
   a physical target;
   a camera positioned to view at least a portion of the physical target, the camera being configured to capture images of the portion of the physical target;
   one or more computers communicatively coupled with the camera and configured to receive the images and to process at least one of the images to determine an orientation of the physical target, correct spatial perspective distortion for the physical target, establish a metric for the physical target that relates a pixel-to-pixel distance with a real-world distance, or a combination thereof, and the one or more computers are configured to, in real-time during a shooting session:
      compare respective images in a sequence of the images to identify image data representing a projectile having hit the physical target,
      determine a point of impact of the projectile on the physical target based on the image data representing the projectile having hit the physical target, and
      provide the determined point of impact for scoring and presentation on a display device.
Example 2. The system of Example 1, wherein the one or more computers are configured to:
   compare sequential images in the sequence of images to identify a first image having a difference from a second image, the second image being prior to the first image in the sequence of images;
   compare sequential images in the sequence of images to identify a third image having no difference from a prior image, the prior image being prior to the third image in the sequence of images, and the prior image being the first image or a subsequent image between the first image and the third image in the sequence of images; and
   set a time of impact of the projectile on the physical target in accordance with a capture time of the first image.
Example 3. The system of Example 2, wherein the sequence of images is a continuous video stream from the camera, and the respective images in the sequence of images are a subset of the continuous video stream.
Example 4. The system of any of Examples 1-3, wherein the one or more computers are configured to:
   find an approximate location of impact of the projectile;
   identify a sub-region of the portion of the physical target using the approximate location of impact, the sub-region including the approximate location of impact and at least four reference points;
   calculate a local homography matrix using the at least four reference points;
   transform the image data using the local homography matrix to produce transformed image data with reduced or eliminated local spatial perspective distortion; and
   analyze the transformed image data to locate the point of impact.
Example 5. The system of Example 4, wherein the one or more computers are configured to:
   calculate a global homography matrix using at least four additional reference points; and
   transform the respective images in the sequence of the images using the global homography matrix to reduced global spatial perspective distortion.
Example 6. The system of Example 4 or Example 5, wherein the one or more computers are configured to identify the sub-region as at least five separate sub-regions, one of the at least five separate sub-regions including the approximate location of impact, and remaining ones of the at least five separate sub-regions including respective ones of the at least four reference points, wherein the image data is in the one of the five separate sub-regions, and wherein the one or more computers are configured to calculate the local homography matrix so as to force the at least four reference points to fall exactly on at least four predefined locations for the physical target.
Example 7. The system of Example 6, wherein the at least four reference points forced to fall exactly on the at least four predefined locations are fiducials located around one of multiple bullseyes on the physical target, and the fiducials are used to establish the metric for the physical target that relates the pixel-to-pixel distance with the real-world distance.
Example 8. The system of any of Examples 1-7, wherein the one or more computers are configured to determine the orientation of the physical target using at least one binary square fiducial marker.
Example 9. The system of any of Examples 1-8, wherein the one or more computers are configured to determine the point of impact using a radial symmetry method that analyzes the image to locate the point of impact of the projectile on the physical target with sub-caliber precision; and optionally, wherein the one or more computers are configured to process the at least one of the images using a separate distortion correction for each respective color image data channel; and further optionally, wherein the at least one of the images has red, green, blue and white image data channels, and the white image data channel includes data resulting from constant or flashing near infrared illumination.
Example 10. The system of any of Examples 1-9, wherein the image data represents heat generated by the projectile having hit the physical target, the camera comprises an infrared camera that is responsive to electromagnetic radiation having a wavelength between 3 microns and 15 microns, inclusive, and the image data is produced by the electromagnetic radiation representing thermal contrast at and around the point of impact.
Example 11. The system of any of Examples 1-9, wherein the camera comprises a visible light camera and an infrared camera, and the one or more computers are configured to determine the orientation, correct the spatial perspective distortion and establish the metric for the physical target using data from the visible light camera, and the one or more computers are configured to compare the respective images and determine the point of impact using data from the infrared camera.
Example 12. The system of any of Examples 1-9, wherein the image data represents heat generated by the projectile having hit the physical target, and the physical target comprises an agent that changes an optical characteristic of reflected electromagnetic radiation in response to the heat generated by the projectile having hit the physical target.
Example 13. The system of Example 12, wherein the camera comprises a visible light camera.
Example 14. The system of Example 12, wherein the agent comprises a thermochromic material that changes color when heated.
Example 15. The system of any preceding Example, comprising:
   the display device positioned in front of, or adjacent to, the physical target to provide information to a person engaged in the shooting session; and
   bullet proof transparent material positioned in front of the display device, wherein the bullet proof transparent material is angled to deflect bullets in a direction that is away from both the physical target and the person.
Example 16. The system of any preceding Example, comprising a light source, wherein the one or more computers are configured to:
   analyze at least a portion of the sequence of images to assess lighting conditions for the physical target; and
   dynamically control the light source based on the lighting conditions to improve lighting intensity and uniformity on the target.
Example 17. A system comprising:
   first and second cameras having a defined position and orientation in three-dimensional space with respect to at least one sensor configured to generate data usable to determine a three-dimensional path of a projectile shot from a gun; and
   one or more computers communicatively coupled with the first and second cameras, wherein the one or more computers are configured to
      locate in respective images from the first and second cameras at least three reference points on a physical target placed in a field of view of each of the first and second cameras,
      determine a position and orientation of the physical target in three-dimensional space with respect to the first and second cameras using the at least three reference points,
      identify a scoring region of the physical target for a shooter of the gun,
      find a point of impact of the projectile on the physical target in accordance with an intersection of the three-dimensional path with the physical target, the intersection being established using (i) the determined position and orientation of the physical target with respect to the first and second cameras and (ii) the defined position and orientation of the first and second cameras with respect to the at least one sensor, and
      provide information regarding the scoring region and the point of impact for scoring of the shot by the shooter and presentation on a display device.
Example 18. The system of Example 17, wherein the one or more computers are configured to:
   analyze a sequence of images from at least one of the first and second cameras to find a hit point of the projectile on the physical target;
   determine a difference between the hit point and the point of impact; and
   adjust the defined position and orientation of the first and second cameras with respect to the at least one sensor based on the difference between the hit point and the point of impact.
Example 19. The system of Example 17 or Example 18, wherein the one or more computers are configured to:
   re-determine the determined position and orientation of the physical target in three-dimensional space with respect to the first and second cameras, after the shot by the shooter, using the at least three reference points.
Example 20. The system of any of Examples 17-19, wherein the physical target includes one or more binary square fiducial markers, and the one or more computers are configured to:
   locate points on the one or more binary square fiducial markers as the at least three reference points; and
   identify the scoring region for the physical target using data encoded in the one or more binary square fiducial markers to identify the physical target as a specific target from a set of predetermined targets.
Example 21. The system of any of Examples 17-19, wherein the physical target includes alphanumeric data, and the one or more computers are configured to:
   perform optical character recognition to determine the alphanumeric data, and
   identify the scoring region for the physical target by accessing a database using the alphanumeric data to identify the physical target as a specific target from a set of predetermined targets.
Example 22. The system of Example 20 or Example 21, wherein the physical target is a three-dimensional physical target with a depth dimension larger than a sheet of paper.
Example 23. The system of any of Examples 17-19, wherein the physical target includes target bulls, and the one or more computers are configured to:
   locate the at least three reference points as at least four of the target bulls, at least four fiducial marks associated with one or more of the target bulls, or both;
   select one of the target bulls as a next sub-target;
   provide information regarding the next sub-target to the display device; and
   identify the scoring region by processing at least one image of the next sub-target from at least one of the first and second cameras using a circular, rotational and/or radial symmetry algorithm.
Example 24. The system of any of Examples 17-19, wherein the physical target is a three-dimensional physical target with a depth dimension larger than a sheet of paper, and the one or more computers are configured to:
   locate the at least three reference points by performing image analysis on the respective images from the first and second cameras to find matching points; and
   determine the position and orientation of the three-dimensional physical target in three-dimensional space by performing three-dimensional reconstruction in accordance with epipolar geometry to produce a three-dimensional model of the three-dimensional physical target.
Example 25. The system of Example 24, wherein the at least three reference points comprise fiducial marks placed at known locations on the three-dimensional physical target.
Example 26. The system of Example 24, wherein the one or more computers are configured to:
   compare the three-dimensional model of the three-dimensional physical target to different three-dimensional models of various targets in a database of predetermined targets; and
   identify the scoring region for the three-dimensional physical target by retrieving the scoring region from the database for one of the predetermined targets that matches the three-dimensional model of the three-dimensional physical target.
Example 27. The system of Example 24, wherein the one or more computers are configured to:
   identify features of interest in the three-dimensional model of the three-dimensional physical target;
   select one of the features of interest as a next sub-target;
   identify the scoring region as a prominent location in the next sub-target; and
   provide information regarding the prominent location in the next sub-target to the display device.
Example 28. The system of any of Examples 17-27, comprising:
   the display device positioned in front of, or adjacent to, the physical target to provide information to the shooter; and
   bullet proof transparent material positioned in front of the display device, wherein the bullet proof transparent material is angled to deflect bullets in a direction that is away from both the physical target and the shooter.
Example 29. The system of any of Examples 17-27, wherein the display device is a mobile phone or tablet computer of the shooter.
Example 30. The system of Example 28 or Example 29, wherein the one or more computers are configured to:
   calculate a score for the shot by the shooter based on the scoring region and the point of impact; and
   provide the score as the information shown on the display device.
Example 31. The system of any of Examples 17-30, wherein the at least one sensor comprises a stereo camera of a trajectory locating subsystem, which is distinct from a target viewing subsystem comprising the first and second cameras.
Example 32. The system of any of Examples 17-30, wherein the at least one sensor comprises at least one radar sensor of an acoustic trajectory locating subsystem, which is distinct from a target viewing subsystem comprising the first and second cameras.
Example 33. The system of any of Examples 17-30, wherein the at least one sensor comprises at least one microphone of a trajectory locating subsystem, which is distinct from a target viewing subsystem comprising the first and second cameras.
Example 34. The system of any of Examples 17-30, wherein the at least one sensor comprises the first and second cameras.

Similar operations for one or more computers as described in Examples 1 to 34 can be implemented as one or more methods, and can be performed in a system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations as describes in any one of the Examples 1 to 34 can also be implemented.

What is claimed is:

1. A system comprising:
a physical target;
a camera positioned to view at least a portion of the physical target, the camera being configured to capture images of the portion of the physical target;
one or more computers communicatively coupled with the camera and configured to receive the images and to process at least one of the images to determine an orientation of the physical target, correct spatial perspective distortion for the physical target, establish a metric for the physical target that relates a pixel-to-pixel distance with a real-world distance, or a combination thereof, and the one or more computers are configured to, in real-time during a shooting session:
compare respective images in a sequence of the images to identify image data representing a projectile having hit the physical target,
determine a point of impact of the projectile on the physical target based on the image data representing the projectile having hit the physical target, and
provide the determined point of impact for scoring and presentation on a display device.

2. The system of claim 1, wherein the one or more computers are configured to:
compare sequential images in the sequence of images to identify a first image having a difference from a second image, the second image being prior to the first image in the sequence of images;
compare sequential images in the sequence of images to identify a third image having no difference from a prior image, the prior image being prior to the third image in the sequence of images, and the prior image being the first image or a subsequent image between the first image and the third image in the sequence of images; and
set a time of impact of the projectile on the physical target in accordance with a capture time of the first image.

3. The system of claim 2, wherein the sequence of images is a continuous video stream from the camera, and the respective images in the sequence of images are a subset of the continuous video stream.

4. The system of any of claims 1-3, wherein the one or more computers are configured to:
find an approximate location of impact of the projectile;
identify a sub-region of the portion of the physical target using the approximate location of impact, the sub-region including the approximate location of impact and at least four reference points;
calculate a local homography matrix using the at least four reference points;
transform the image data using the local homography matrix to produce transformed image data with reduced or eliminated local spatial perspective distortion; and
analyze the transformed image data to locate the point of impact.

5. The system of claim 4, wherein the one or more computers are configured to:
calculate a global homography matrix using at least four additional reference points; and
transform the respective images in the sequence of the images using the global homography matrix to reduced global spatial perspective distortion.

6. The system of claim 4, wherein the one or more computers are configured to identify the sub-region as at least five separate sub-regions, one of the at least five separate sub-regions including the approximate location of impact, and remaining ones of the at least five separate sub-regions including respective ones of the at least four reference points, wherein the image data is in the one of the five separate sub-regions, and wherein the one or more computers are configured to calculate the local homography matrix so as to force the at least four reference points to fall exactly on at least four predefined locations for the physical target.

7. The system of claim 6, wherein the at least four reference points forced to fall exactly on the at least four predefined locations are fiducials located around one of multiple bullseyes on the physical target, and the fiducials are used to establish the metric for the physical target that relates the pixel-to-pixel distance with the real-world distance.

8. The system of any of claims 1-3, wherein the one or more computers are configured to determine the orientation of the physical target using at least one binary square fiducial marker.

9. The system of any of claims 1-3, wherein the one or more computers are configured to determine the orientation of the physical target using at least one binary square fiducial marker.

10. The system of any of claims 1-3, wherein the one or more computers are configured to determine the point of impact using a radial symmetry method that analyzes the image to locate the point of impact of the projectile on the physical target with sub-caliber precision.

11. The system of claim 10, wherein the one or more computers are configured to process the at least one of the images using a separate distortion correction for each respective color image data channel.

12. The system of claim 1, wherein the camera is a first camera, the system comprises a second camera, the first and second cameras have a defined position and orientation in three-dimensional space with respect to at least one sensor configured to generate data usable to determine a three-dimensional path of the projectile, and the one or more computers are communicatively coupled with the first and second cameras and are configured to:
locate in respective images from the first and second cameras at least three reference points on the physical target placed in a field of view of each of the first and second cameras;
determine a position and orientation of the physical target in three-dimensional space with respect to the first and second cameras using the at least three reference points;
find a hit point of the projectile on the physical target in accordance with an intersection of the three-dimensional path with the physical target, the intersection being established using (i) the determined position and orientation of the physical target with respect to the first and second cameras and (ii) the defined position and orientation of the first and second cameras with respect to the at least one sensor;
determine a difference between the hit point and the point of impact; and
adjust the defined position and orientation of the first and second cameras with respect to the at least one sensor based on the difference between the hit point and the point of impact.

13. The system of claim 12, wherein the one or more computers are configured to:
re-determine the determined position and orientation of the physical target in three-dimensional space with respect to the first and second cameras, after a shot during the shooting session, using the at least three reference points.

14. The system of claim 12, wherein the one or more computers are configured to:
identify a scoring region of the physical target; and
provide information regarding the scoring region for the scoring and presentation on the display device.

15. The system of claim 14 wherein the physical target includes one or more binary square fiducial markers, and the one or more computers are configured to:
locate points on the one or more binary square fiducial markers as the at least three reference points; and
identify the scoring region for the physical target using data encoded in the one or more binary square fiducial markers to identify the physical target as a specific target from a set of predetermined targets.

16. The system of claim 14, wherein the physical target includes alphanumeric data, and the one or more computers are configured to:
perform optical character recognition to determine the alphanumeric data, and
identify the scoring region for the physical target by accessing a database using the alphanumeric data to identify the physical target as a specific target from a set of predetermined targets.

17. The system of claim 14, wherein the physical target includes target bulls, and the one or more computers are configured to:
locate the at least three reference points as at least four of the target bulls, at least four fiducial marks associated with one or more of the target bulls, or both;
select one of the target bulls as a next sub-target;
provide information regarding the next sub-target to the display device; and
identify the scoring region by processing at least one image of the next sub-target from at least one of the first and second cameras using a circular, rotational and/or radial symmetry algorithm.

18. The system of claim 12, wherein the physical target is a three-dimensional physical target with a depth dimension larger than a sheet of paper, and the one or more computers are configured to:
locate the at least three reference points by performing image analysis on the respective images from the first and second cameras to find matching points; and
determine the position and orientation of the three-dimensional physical target in three-dimensional space by performing three-dimensional reconstruction in accordance with epipolar geometry to produce a three-dimensional model of the three-dimensional physical target.

19. The system of any of claims 12-18, wherein the at least one sensor comprises a stereo camera of a trajectory locating subsystem, which is distinct from a target viewing subsystem comprising the first and second cameras.

20. The system of any of claims 12-18, wherein the at least one sensor comprises at least one radar sensor of an acoustic trajectory locating subsystem, which is distinct from a target viewing subsystem comprising the first and second cameras.

21. The system of any of claims 12-18, wherein the at least one sensor comprises the first and second cameras.

22. The system of any of claim 1-3 or 12-18, comprising:
the display device positioned in front of, or adjacent to, the physical target to provide information to a person engaged in the shooting session; and
bullet proof transparent material positioned in front of the display device, wherein the bullet proof transparent material is angled to deflect bullets in a direction that is away from both the physical target and the person.

23. The system of any of claim 1-3 or 12-18, wherein the display device is a mobile phone or tablet computer of a person engaged in the shooting session.
